(19) United States
(12) Patent Application Publication
(10) Pub. No.: US 2025/0236030 A1
(43) Pub. Date: Jul. 24, 2025

(54) Knife with a Pivot Lock

(71) Applicant: Beren McKay, Edmonds, WA (US)

(72) Inventor: Beren McKay, Edmonds, WA (US)

(21) Appl. No.: 18/419,286

(22) Filed: Jan. 22, 2024

(51) Int. Cl. B26B 1/04; B26D 1/10

(52) U.S. Cl. CPC B26B 1/04; B26D 1/10

(57) ABSTRACT

In some embodiments, a knife pivot lock comprises a hollow pivot shaft extending through a pivot hole in a blade and a knife frame, and fastened to the knife frame, the hollow pivot shaft having a lock rod within the hollow shaft wherein the lock rod has a lock protrusion, the hollow pivot shaft having on opening through a portion of a sleeve wall to receive the lock protrusion, wherein in a locked state the protrusion is placed within a blade lock recess and a lock recess within the knife frame thereby locking the knife blade.

### BACKGROUND

### Field of the Invention

The present disclosure relates to knives, tools and utensils, and in particular, to a lock which can be actuated partially within a pivot and that locks a knife, tool or utensil or other pivoting devices.

### Prior Art

Knife locks are a popular safety mechanism that prevents a knife blade from closing from an open position or from opening unexpectedly. Conventional knife locks have a post, flange or other protrusion that is moved within a knife handle to block the knife blade from pivoting. However conventional knife locks may be non-intuitive to operate or may complicate knife parts and assembly.

### SUMMARY

In some embodiments, a knife with a pivot lock comprises a hollow pivot shaft with a locking nut placed within the shaft and extending through an opening in the shaft sleeve and into a lock recess in a blade tang and a lock recess within a liner, handle or frame. Also, the knife may have a first handle portion having a corresponding pivot hole to receive a pivot post with the pivot hole being substantially round with a lock recess defining a notch extending radially out from the substantially round portion; at least a first liner adjacent to the first handle portion and having a corresponding pivot hole to receive a pivot post, wherein the pivot hole on the first liner is substantially round with a lock recess in alignment with the lock recess in the first handle portion, and a blade having a pivot hole and a lock recess in alignment with the lock recess in the first handle portion and the lock recess in the first liner, and a hollow pivot shaft extending through the pivot holes, the hollow pivot shaft having a lock rod within the hollow shaft wherein the lock rod has a lock protrusion, the hollow pivot shaft having an opening through a portion of a sleeve wall to receive the lock protrusion, wherein in a locked state the protrusion is placed within the blade lock recess and the first liner lock recess thereby preventing the knife blade from pivoting.

In some embodiments, a knife pivot lock comprises a hollow pivot shaft extending through a pivot hole in a blade and a knife frame, and fastened to the knife frame, the hollow pivot shaft having a lock rod within the hollow shaft wherein the lock rod has a lock protrusion, the hollow pivot shaft having an opening through a portion of a sleeve wall to receive the lock protrusion, wherein in a locked state the protrusion is placed within a blade lock recess and a lock recess within the knife frame thereby locking the knife blade.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exploded view of a knife with a pivot lock.

FIG. 2 is a section view showing an embodiment pivot lock in an unlocked orientation.

FIG. 3 is a section view showing an embodiment pivot lock in a locked orientation.

FIG. 4 is an isolated view illustrating a pivot lock assembly as depicted.

FIG. 5 is a perspective view showing an assembled embodiment knife.

FIG. 6 is a perspective view of a subset of components of an embodiment knife to illustrate the arrangement of the lock rod and the lock recess in a blade in the unlocked orientation.

### DETAILED DESCRIPTION

In the present disclosure, certain specific details are set forth in order to provide a thorough understanding of various embodiments of the disclosure. However, upon reviewing this disclosure one skilled in the art will understand the various embodiments disclosed herein may be practiced without many of these details. In other instances, some well-known mechanical principles, structures and materials, have not been described in detail to avoid unnecessarily obscuring the descriptions of the embodiments of the disclosure.

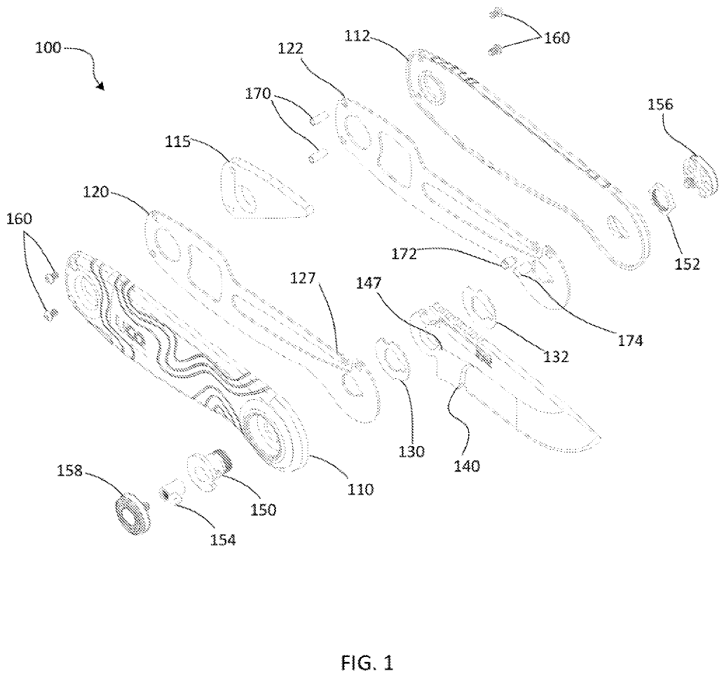

Referring now to FIG. 1, a knife with a pivot lock 100 is shown in an exploded view illustrating the basic components in one embodiment. A blade 140 having a pivot hole and a lock recess is shown between adjacent washers 130 and 132. In the present embodiment the washers include a lock recess that is in alignment with blade 140 when blade 140 is in the open orientation. Stepped pin 172 resides within a hole in a cantilevered spring in liner 120 and liner 122, which are adjacent to washers 130 and 132, housing the washers between the liners and the blade 140 between the washers. In this embodiment, the blade tang has a contoured section to receive the stepped pin 172 with the cantilevered spring under less tension and holding the blade in the open or closed position with a slip joint, as disclosed herein. Back spacer 115 resides between the liners distal to the pivot end of the blade. In this embodiment, back spacer 115 receives threaded tubes 170 to which screws 160 will be fastened to, through liner 120 and 122 and handle 110 and handle 112. As contoured section 148 is biased against movement by stepped pin 172 in liner spring 127, the blade 140 can still be rotated about the pivot without undue force. However, some embodiments may utilize other components for a slip-joint than a liner spring or may utilize no slip-joint in conjunction with a pivot lock as disclosed herein.

In this slip-joint held orientation, a user can press on button 156 or 158 and push the lock rod 154 through pivot shaft 150 such that lock protrusion 155 is moved within lock recesses within the blade 140, liners 120 and/or 122, and handle portions 110 and/or 112. To close the blade 140, the button 156 or 158 (the opposite button to which locked it) is then actuated to push lock rod 154 such that lock protrusion 155 is no longer within the lock recess 147 within the blade 140. In this way, the blade 140 is free to rotate again upon overcoming the slip-joint.

In the present embodiment, pivot shaft 150 has a threaded end and a flanged end, where the flanged end has an opening through the sleeve wall on the outer circumference of the pivot shaft 150. The threaded end of pivot shaft 150 attaches to pivot nut 152 through the knife liners and handles. In other embodiments, pivot shaft may be affixed to a knife frame, or only through liners and the blade, through a frame and or handle and the liners and blade, etc.

In the present embodiment, pivot shaft 150 is hollow and houses lock rod 154 having a lock protrusion on one end of the lock rod 154, wherein the lock protrusion will slide within the opening through the sleeve of pivot shaft 150 between a locked position and an unlocked position. In some embodiments, pivot shaft 150 is hollow for the entire length of the shaft, however in other embodiments pivot shaft is merely partially hollow such as to fit part of the lock arm within the outer circumference of the pivot shaft 150. For example, pivot shaft can have a non-uniform hollow section or may have an opening running the length of the pivot shaft sleeve, as non-limiting examples.

In some embodiments, the flanged end of pivot shaft may have a flange around the circumference of an end of pivot shaft. In other embodiments, the flange may extend only a portion of the circumference around the pivot shaft and may have a flange opening connected to an opening in the sleeve wall of the pivot shaft to receive the lock protrusion. In some embodiments the lock protrusion may exist in either on unlocked state or a locked state while not within the flange opening, while in other embodiments the lock protrusion may be within the flange opening in one or both of an unlocked state or a locked state.

In some embodiments, the flange may be monolithic with the pivot shaft, while in other embodiments it may be a separate flange that is affixed to the pivot shaft, such as a threaded connection, a snap or press fit connection, or other means to rigidly affix the flange to the pivot shaft. A snap ring, a nut, or other connection may also operate as a flange within the principles of this disclosure. Additionally, the threaded nut may be replaced with a snap or press fit connection to the pivot shaft, or other means to rigidly affix it to the pivot shaft and practice the general teachings in this disclosure.

In this embodiment, the lock protrusion will protrude through the opening in the pivot shaft 150 sleeve wall and through the lock recess in the blade 140, a liner 120 and a handle 110. Some embodiments may have a lock recess in both handles and in both liners, allowing the lock to lock between more components or allowing the lock to be configured as a left-hand orientation lock or a right-hand orientation lock by removing the pivot shaft 150 and lock rod 154 assemblies and orienting them in the opposite fashion through the pivot holes. Lock rod 154 receives button 158 on one end of the lock rod and button 156 on the opposing end of the lock rod.

In some embodiments, lock protrusion may be a separate component from lock bar and may be affixed to it in a rigid fashion. For example, lock protrusion may be a socket head cap screw or other screw, a snap fit or press fit part into the shaft of lock bar, may be affixed with a spring pin, may be soldered or glued, or any other known method of affixing knife components known in the art.

In the present embodiment, button 158 and button 156 have recesses to receive one or more magnets to hold the lock rod 154 in an unlocked or in a locked position, according to user selection. While the present embodiment uses magnets, other embodiments can use detents, expanders, or other mechanical means that bias the button toward the selected position and against movement from the position, without pressing button 158 or button 156.

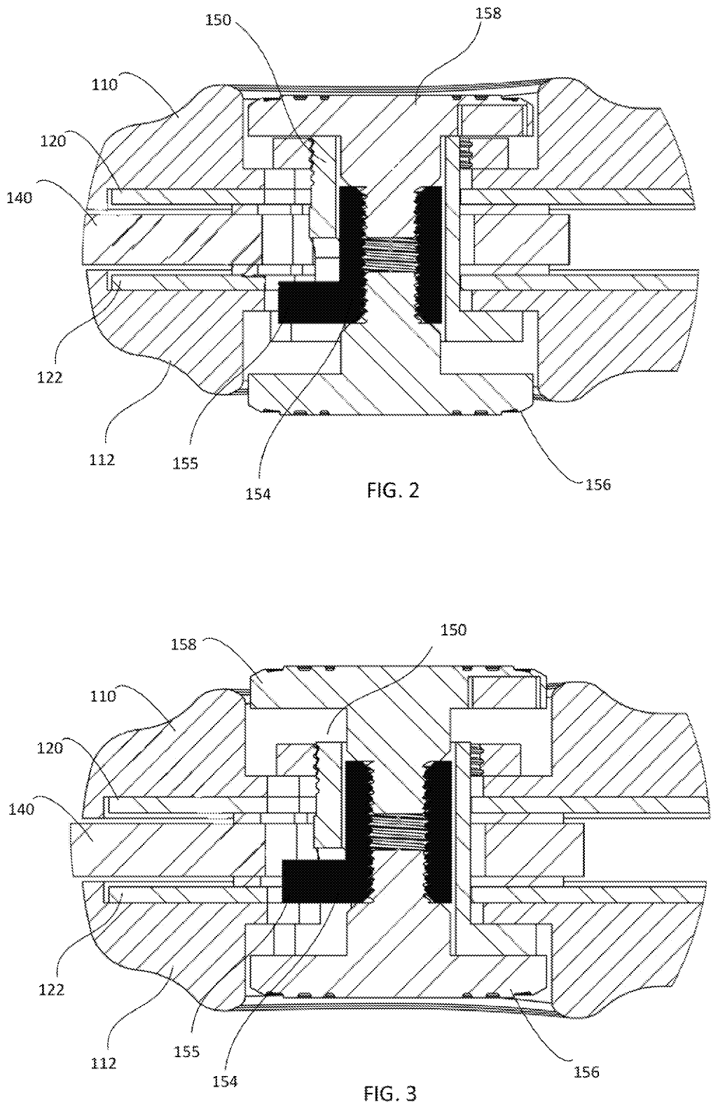

Referring now to FIGS. 2-3, the pivot lock assembly is shown in an unlocked and a locked state. In FIG. 2, knife 100 is shown in a section view showing blade 140 around pivot shaft 150. Blade 140 is between liner 122 and liner 120, which are between first handle portion 110 and second handle portion 112. Within pivot shaft 150 resides lock rod 154 having a lock protrusion 155. In the present embodiment, lock protrusion 155 extends through an opening in the sleeve of pivot shaft 150. In this way, lock rod 154 is primarily within pivot shaft 150 except for lock protrusion 155 which extends through the opening in the shaft and into lock recesses in the liner 122 and/or handle 112, yet not within the aligned lock recess in blade 140. On either end of lock rod 154 are buttons 158 and 156. Therefore in FIG. 2, the lock protrusion is not extending through blade 140 and is in an unlocked position.

In FIG. 3, knife 100 is shown in a section view showing blade 140 around pivot shaft 150. Blade 140 is between liners 120 and 122 which are between handle portions 110 and 112, as disclosed above with reference to FIG. 2. In the present embodiment, lock protrusion 155 extends through an opening in the sleeve of pivot shaft 150. In this way, lock rod 154 is primarily within pivot shaft 150 except for lock protrusion 155 which extends through the opening in the shaft and into lock recesses in the liner 122 and/or handle 112, and in FIG. 3 within the aligned lock recess in blade 140. On either end of lock rod 154 are buttons 158 and 156. In FIG. 3, the lock protrusion extends into blade 140 and abuts against the lock recess within liner 122 and/or the handle 112, and therefore the blade 140 is in a locked position.

With reference to FIGS. 1-3, one embodiment of a pivot lock will now be described in more detail. Knife 100 with a pivot lock may include a first handle portion 110 and a second handle portion 112, with each handle portion having a corresponding pivot hole to receive a pivot post (or shaft) 150, wherein the pivot hole on the first handle portion 110 is substantially round with a lock recess defining a notch extending radially out from the substantially round portion. This embodiment may also have a first liner 120 and a second liner 122 adjacent to the first handle portion 110 and second handle portion 112, and placed between the handle portions, with each liner having a corresponding pivot hole to receive a pivot shaft 150, wherein the pivot hole on the first liner 120 is substantially round with a lock recess in alignment with the lock recess in the first handle portion 110.

The present embodiment further has a blade 140 disposed between the two liner portions 120 and 122, the blade 140 having a pivot hole and a lock recess 147 in alignment with the lock recess in the first handle portion 110 and the lock recess in the first liner 120. The present embodiment also includes a hollow pivot shaft 150 extending through the pivot holes, the hollow pivot shaft 150 having a lock rod 154 within the hollow shaft wherein the lock rod has a lock protrusion 155. The hollow pivot shaft 150 further having on opening 151 through a portion of a sleeve wall to receive the lock protrusion 155, wherein in a locked state the lock protrusion 155 is placed within the blade lock recess 147 and the first liner lock recess thereby preventing the knife blade from pivoting. In some embodiments, the lock rod 155 may be partially within the hollow pivot shaft 150 and partially outside the circumference of the hollow pivot shaft 150. In some embodiments, knife 100 may have the pivot shaft 150 fixed stationary to the first and second knife handles 110 and 120.

In this embodiment knife 100, the pivot hole on the second handle portion 112 may be substantially round and further have a lock recess defining a notch extending radially out from the substantially round portion, and the pivot hole on the second liner 122 may also be substantially round with a lock recess in alignment with the lock recess in the first liner portion 120. In some embodiments, a pivot hole may be non-round. In this manner, in a locked state the lock protrusion 155 is placed within the blade lock recess 147 and the second liner lock recess thereby preventing the knife blade from pivoting. Additionally, in this embodiment knife 100, the blade lock recess 147 may alternatively be a separate hole through the blade 140 than the pivot hole.

With reference to some embodiments, knife 100 may further have a first button 156 connected with a first end of the lock rod 154, and a second button 158 connected with a second end of the lock rod 154, where the first button 156 and the second button 158 each have a magnet embedded within the button to hold the lock rod 154 in an unlocked or in a locked position, depending on user selection.

In some embodiments, the pivot shaft 150 may have a flanged end and a threaded end, wherein the threaded end is to be placed through the pivot holes of the handle, liner and blade with the flanged end on the outside of the first handle portion 110 and wherein the threaded end is placed outside the second handle portion 112. In this way, the threaded end of the pivot shaft 150 may receive a pivot nut, where the pivot nut when fastened to the pivot shaft holds the first and second knife handles together. Other embodiments may have separate fasteners to hold the knife handles together.

In some embodiments, a lock rod may be an external sleeve around a pivot shaft, such as a lock rod sleeve. For example, a lock rod may have a lock protrusion extending radially out from the lock rod that interfaces with a lock recess within a blade tang and a lock recess within a knife liner, a knife handle or a knife frame, or any combination thereof. In this embodiment, a button may be in mechanical communication with the lock rod sleeve such that the lock rod sleeve can be adjusted to place the lock protrusion within the lock recess in the blade and a lock recess in at least one of a knife liner, a knife handle or a knife frame, and thus obstruct rotation of the blade about the pivot and locking the blade in an open or a closed orientation. In this embodiment, the button may also be used to adjust lock rod sleeve so the lock protrusion is not within the lock recess in the blade and a lock recess in at least one of a knife liner, a knife handle or a knife frame, allowing rotation of the blade about the pivot.

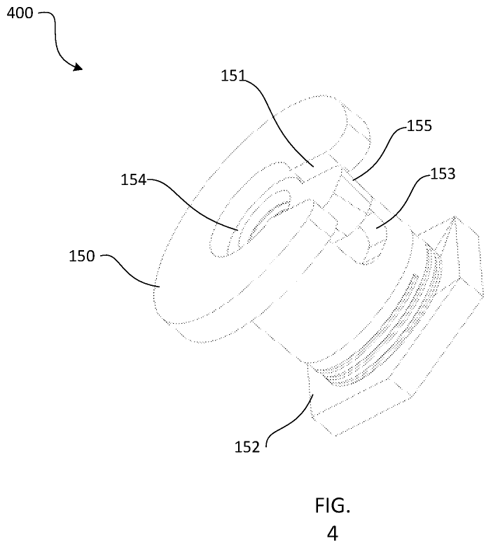

With reference to FIG. 4, the pivot lock assembly is depicted in an isolated view 400 to illustrate the pivot lock in a simplified fashion. Within the knife 100 as shown in FIGS. 2-3, portions of the pivot lock assembly will interface with additional knife parts for mounting, for locking and unlocked orientations, etc. Isolated view 400 of the pivot lock assembly is shown with pivot shaft 150 being coupled to pivot nut 152. Within the hollow center of pivot shaft 150 is lock rod 154 having lock protrusion 155. An opening 151 in the sleeve of pivot shaft 150 extends along the circumference of the pivot shaft until the end of the opening at reference 153. In this orientation, lock protrusion 155 is not proximal to the opening end 153, and in this way is in an unlocked state and is not engaging the blade 140. As lock rod 154 is pushed axially through pivot shaft 150, lock protrusion 155 will travel adjacent to opening end 153 and enter into the lock recess within blade 140 (not shown), and furthermore be within the lock recess in liner 122 and handle 112. In this way, the rigid lock protrusion 155 wedges between blade 140 and liner 122 when the blade is in the open position and therefore locks the blade. In this locked position, button 158 is held against pivot shaft 150 with at least one embedded magnet in the button.

While this current embodiment illustrates a lock protrusion 155 within a same cross-section as the lock rod 154, some embodiments may utilize a separate post from the center of the lock rod 154 and additionally have a pivot hole in the blade, liner or frame that is separate from a lock recess in the same blade, liner or frame. In this embodiment with a separate pivot hole and lock recess, the lock rod may still primarily reside within the hollow pivot shaft 150 and be toggled between a locked position and an unlocked position by buttons 156 and 158.

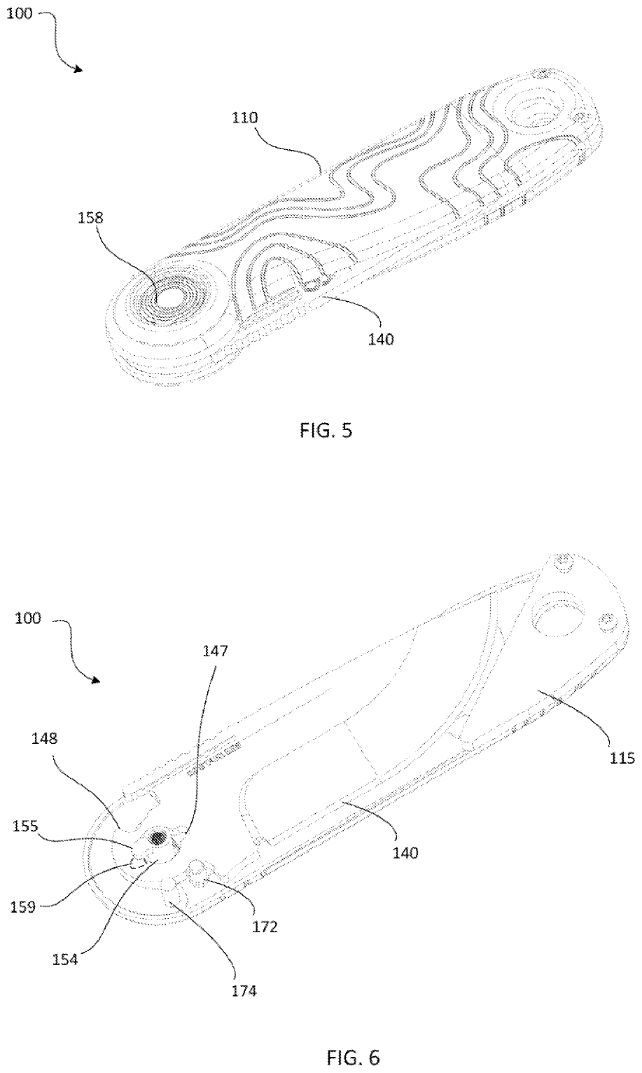

Referring now to FIG. 5, knife 100 is shown assembled in a perspective view, illustrating blade 140, button 158 coupled to the lock rod through the pivot shaft, and handle 110. In this illustration, the intuitively placed lock button within the pivot post placement is shown.

FIG. 6 shows some of the components of knife 100 with others removed to show the arrangement of the lock rod 154 and the lock recess 147 in blade 140 in the unlocked orientation. As can be seen, the lock protrusion 155 is out of alignment with blade lock recess 147. In some embodiments, a blade may have more than one lock recess. For example, dashed line 159 illustrates another potential recess to receive lock protrusion 155. The potential lock recess shown with dashed line 159 would provide a pivot lock while a blade is in a closed position. FIG. 6 also depicts the contoured indentation 148 in blade 140 tang that receives stepped pin 172 which coordinates with a cantilevered spring 127 in the liner 120 and/or liner 122, to create a slip-joint and partially bias the blade 140 against closing.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A knife with a pivot lock, the knife comprising:
a first handle portion having a corresponding pivot hole to receive a pivot post, the pivot hole on the first handle portion a lock recess defining a notch extending radially out from the pivot hole;
a first liner adjacent to the first handle portion, the liner having a corresponding pivot hole to receive a pivot post, wherein the pivot hole on the first liner has a lock recess in alignment with the lock recess in the first handle portion;
a blade disposed adjacent to the liner and first handle portion, the blade having a pivot hole and a lock recess; and
a hollow pivot shaft extending through the pivot holes, the hollow pivot shaft having a lock rod within the hollow shaft wherein the lock rod has a lock protrusion, the hollow pivot shaft having an opening through a portion of a sleeve wall to receive the lock protrusion, wherein in a locked state the lock protrusion is placed within the blade lock recess and the first liner lock recess thereby preventing the knife blade from pivoting.

2. The knife of claim 1, further having a second handle portion wherein the pivot hole on the second handle portion is substantially round and further has a lock recess defining a notch extending radially out from the substantially round portion;
the knife further having a second liner, wherein the pivot hole on the second liner is substantially round with a lock recess in alignment with the lock recess in the first liner portion; and
wherein in a locked state the protrusion is placed within the blade lock recess and the second liner lock recess thereby preventing the knife blade from pivoting.

3. The knife of claim 1, wherein the blade lock recess is separate from the pivot hole.

4. The knife of claim 1, further having a first button connected with a first end of the lock rod, and a second button connected with a second end of the lock rod, wherein the first button and the second button each have a magnet embedded in the button to hold the lock rod in an unlocked or in a locked position.

5. The knife of claim 1, wherein the lock rod is partially within the hollow pivot post and partially outside the circumference of the hollow pivot post.

6. The knife of claim 1, wherein the pivot post is fixed stationary to the first and second knife handles.

7. The knife of claim 1, wherein the pivot shaft has a flanged end and a threaded end, wherein the threaded end is to be placed through the pivot holes with the flanged end on the outside of the first handle and wherein the threaded end is placed outside the second handle and is to receive a pivot nut, where the pivot nut when fastened to the pivot shaft holds the first and second knife handles together.

8. The knife of claim 7, wherein the flanged end of the pivot shaft is only partially flanged around the circumference of the shaft and wherein a portion without a flange is in open to the opening in the sleeve wall to receive the lock protrusion.

9. The knife of claim 1, wherein the blade has a tang with a contoured indention to receive a pin and the liner has a cantilevered spring having a pin attached, wherein when the pin is within the contoured indentation, the knife blade is partially biased against movement.

10. The knife of claim 1, wherein the pivot hole is substantially round other than the lock recess defining a notch extending radially out from the pivot hole

11. A knife pivot having a lock, the knife pivot comprising:
a hollow pivot shaft extending through a pivot hole in a blade and a knife frame, the pivot shaft has a flanged end and a threaded end, wherein the threaded end is to be placed through the pivot holes in the blade and the knife frame with the flanged end on the outside a first side of the knife frame and the threaded end is placed outside a second side of the knife frame and is to receive a pivot nut and be fastened to the knife frame;
the hollow pivot shaft having a lock rod within the hollow shaft wherein the lock rod has a lock protrusion, the hollow pivot shaft having an opening through a portion of a sleeve wall to receive the lock protrusion, wherein in a locked state the protrusion is placed within a blade lock recess and a lock recess within the knife frame thereby locking the knife blade.

12. The knife pivot of claim 11, wherein the blade lock recess is separate from the blade pivot hole.

13. The knife pivot of claim 11, further having a first button connected with a first end of the lock rod, and a second button connected with a second end of the lock rod, wherein the first button and the second button each have a magnet embedded in the button to hold the lock rod in an unlocked or in a locked position.

14. The knife pivot of claim 11, wherein the lock rod is partially within the hollow pivot post and partially outside the circumference of the hollow pivot post.

15. The knife pivot of claim 11, wherein the pivot shaft has a flanged end and a threaded end, wherein the threaded end is to be placed through a pivot hole of a knife frame and to receive a pivot nut, where the pivot nut when fastened to the pivot shaft holds the pivot shaft to the knife frame.

16. The knife pivot of claim 15, wherein the flanged end of the pivot shaft is only partially flanged around the circumference of the shaft creating a flange opening, and the flange opening is connected to the opening in the sleeve wall to receive the lock protrusion.
